(19) United States
(12) Patent Application Publication
(10) Pub. No.: US 2017/0297240 A1
(43) Pub. Date: Oct. 19, 2017

(54) FOAM BODY AND APPARATUS AND METHOD OF MAKING THE BODY

(71) Applicant: GRAMMER AG, Amberg (DE)

(72) Inventors: Detlef HAMMERL, Amberg (DE); Peter KRAUS, Schnaittenbach (DE); Helmut KURZ, Sulzbach-Rosenberg (DE)

(21) Appl. No.: 15/484,201

(22) Filed: Apr. 11, 2017

(30) Foreign Application Priority Data
Apr. 14, 2016 (DE) 102016004407.1

(51) Int. Cl. B29C 45/16; B32B 5/20; B32B 5/32; B32B 7/04; B32B 27/06; B29C 45/36; B60N 2/48; B32B 27/40; B29K 105/04; B29L 31/30; B29K 75/00

(52) U.S. Cl. CPC B29C 45/1676; B60N 2/48; B32B 5/20; B32B 5/32; B32B 7/04; B32B 27/065; B32B 27/40; B29C 45/36; B29K 2105/04; B29L 2031/3023; B29C 2045/363; B32B 2266/0278; B32B 2307/536; B32B 2605/003; B29K 2075/00; B60N 2002/4888

(57) ABSTRACT

An apparatus for making a foam material body has a mold comprising at least two mold halves fittable together to form separate first and second mold cavities; a first sprue opening into the first mold cavity, and a second sprue opening into the second mold cavity. The mold parts can be moved between an open and a closed position. Foam can be injected into the first and second mold cavities through the respective sprues. A passage, for example, connects the sprue with the mold cavity. The first mold cavity and the second mold cavity are partitioned from one another in the closed position of the mold.

### FIELD OF THE INVENTION

The present invention relates to an apparatus for making a foam body. In addition, this invention concerns the foam body and a method of making it.

### BACKGROUND OF THE INVENTION

A foam body can be used for example as a cushion for the head restraint of a vehicle seat. The head restraint comprises a head box having a head contact surface that is directly or indirectly mounted on the head box. The head box is mounted on the seat by at least one support rod. The head box is provided with a cushion usually formed by a foam body.

In the state of the art, different types of foam were already combined, for example so that the cushion of the head restraint has a hard core, for example, but a soft shell.

A head restraint is known from DE 101 36 523 where the head box has a cushion that comprises an element composed of a soft foam material of polyurethane, and an insert part of a hard foam material of polyurethane.

A head restraint is described in U.S. Pat. No. 7,926,871 where foam types have different dynamic characteristics in regions that lie vertically one on top of the other.

DE 101 23 704 describes an apparatus for making a multilayer foam cushion body for motor-vehicle cushion parts. A mold core is introduced into a counter-mold element and a first foam is injection-molded around it. Afterward, the foam core is put into an additional counter-mold element and a second foam is injection-molded around it. The second foam has characteristics that are different from the first foam.

### OBJECTS OF THE INVENTION

It is therefore an object of the present invention to provide an apparatus that improves the production of a foam body having different types of foam, with regard to the time required for production.

### SUMMARY OF THE INVENTION

An apparatus for making a foam material body has a mold comprising according to the invention at least two mold halves fittable together to form separate first and second mold cavities;, a first sprue opening into the first mold cavity, and a second sprue opening into the second mold cavity.

The mold parts can be moved between an open and a closed position. Foam can be injected into the first and second mold cavities through the respective sprues. A passage, for example, connects the sprue with the mold cavity. In other words, the mold comprises at least two separate mold cavities each having a separate sprue. The first mold cavity and the second mold cavity are partitioned from one another in the closed position of the mold.

An advantage of the apparatus according to the invention consists in that the first foam cavity can be filled with a first foam and the second cavity with a second foam, at the same time or one shortly after the other, and cured there. The first foam and the second foam have different characteristics. For example, the first foam has a greater hardness than the second foam. In this manner, the production time of foam bodies can be significantly reduced, which leads to a saving in production costs. The molded parts molded in the first mold cavity and in the second mold cavity are parts of an end product.

A foam body for cushioning the head box of a head restraint, for example, can be produced using the apparatus. This body forms the head box of a head restraint for a vehicle seat, and the foam body has a foam having first characteristics in a first region and a foam having second characteristics in at least a second region. For example, the head box can be provided with a soft foam in a head contact region and with a hard foam in the remaining regions.

The mold comprises a mold core, for example, that can be in the mold. The mold core forms at least one wall of at least one mold cavity. The mold core can form a pocket-like recess in a foam body, for example. For example, the mold core forms a recess in a foam body of a head part of a head restraint for a seat. The recess can be provided, for example, for the holding and fitting around a base part of the head restraint, connected with at least one support rod.

According to a special embodiment of the invention, the mold core separates the first mold cavity from the second mold cavity. In this case, the mold core forms at least one surface of the first mold cavity and at least one surface of the second mold cavity. In this manner, the foam body can have a recess for the base part of a head restraint, for example, according to the invention, and the foam body is configured in such a manner that a least two different foam types having different characteristics border on the cavity.

According to one embodiment, the mold core is movably mounted on the mold and can be moved between an demolding position and a working position. In the demolding position, the molded part that has been produced can be removed from the mold, and in the working position, filling the foam into the mold openings is possible. For example, the mold core is mounted on the mold so as to pivot between the demolding position and the working position.

At least one opening, for example, is formed between the two mold cavities. The foam part produced in the first mold cavity and the foam part produced in the second cavity can be connected with one another by the opening. The connection can take place, for example, in that the foam types come into contact in the otherwise separate mold cavities, by way of the opening, and connect in this manner.

Connecting of the foams can take place with material fit, for example. In this case, the foam materials must permit connecting.

According to a special embodiment, at least one connecting element is in the opening, in such a manner that it projects into the first mold cavity and into the second mold cavity for the purpose of connecting the foam parts to be produced in the mold cavities. The connecting element is formed by a material, for example, on which the molded part produced in the first mold cavity and the molded part produced in the second mold cavity can be molded. In other words, after the molding process, the connecting element and the foam part produced in the first mold cavity and the foam part produced in the second mold cavity are connected with one another with material fit and/or shape fit. The opening can be configured between the mold core and the mold, for example.

According to a second aspect, the invention relates to a method of making a foam body. The method is used, for example, to produce cushions of vehicle head restraints. Such head restraints are usually cushioned with foam bodies.

DE 101 23 704 mentioned above, for example, describes such a method from the state of the art.

It was an object of the invention to create a method with which foam bodies having different foam types can be produced with little time expenditure.

The invention is accomplished by a method for making a foam material body in which a connecting element is laid into an opening that connects two mold cavities of a mold. In this regard, the connecting element projects into the first mold cavity and into the second mold cavity. A first foam is injected or poured into the first mold cavity through a first sprue, and a second foam is injected or poured into the second mold cavity through a second sprue, at the same time or one shortly after the other. Subsequently, the foams in the first mold cavity and in the second mold cavity are cured. The foams in the first and second mold cavities connect with the connecting element with material fit and/or shape fit. After curing, the foam body with different types of foam is removed from the mold.

With regard to the advantages of the method, reference is made to the explanations relating to the first aspect of the invention—in order to avoid repetition.

According to an embodiment of the invention, a mold core is in the mold, after the connecting element has been laid in, in such a manner that it separates a first mold cavity from a second mold cavity. With regard to the advantages and embodiments of this characteristic, as well, reference is made to the first aspect of the invention.

Finally, the invention also relates to a foam body for the head restraint of a seat, particularly of a vehicle seat.

With regard to the state of the art, reference is made to the first aspect of the invention.

It was an object of the invention to create a foam body that comprises at least two different types of foam and is improved with regard to its handling.

This task is accomplished by a foam body having at least a first foam and a second foam, where the second foam differs from the first foam with regard to at least one property. The foam body comprises at least one hard foam part and at least one soft foam part, for example. The first foam and the second foam are connected with one another by a connection.

The connection can be formed by a material-fit connection between the first foam and the second foam, for example.

According to an alternative, the connection is formed by a connecting element, for example. The connecting element is connected with the first foam and with the second foam. The connection can be produced by material fit and/or by shape fit, for example. The connecting element can be configured as a connecting mat, for example. In this case, it offers a relative large surface area for connecting with the respective foam.

### BRIEF DESCRIPTION OF THE DRAWING

The above and other objects, features, and advantages will become more readily apparent from the following description, reference being made to the accompanying drawing in which:

FIG. 1 is a section through the apparatus according to the invention where the parts of a mold of the apparatus are open and a mold core is in a removal position;

FIG. 2 is a view like FIG. 1 where a connecting mat is on the mold core of the mold;

FIG. 3 is a view like FIG. 2 where the mold core is in a working position;

FIG. 4 is a view of the mold as in FIG. 3 where a first mold part and a second mold part are in a preclosing position;

FIG. 5 is a view like FIG. 4 where the first mold part and the second mold part are in a closed position and a first foam is filled into a first mold cavity and a second foam is filled into a second mold cavity;

FIG. 6 is a view like FIG. 5 where the sprues are covered by a third mold part for curing of the foam body;

FIG. 7 is a view like FIG. 3 if the open mold with the cured foam body;

FIG. 8 is a view like FIG. 1 of the mold core with the foam body in the removal position; and

FIG. 9 shows the foam body after it is demolded from the mold core and mounted on a base body of a head restraint.

### SPECIFIC DESCRIPTION OF THE INVENTION

An apparatus for making a foam body is shown at 10 in the drawing. The same reference symbols in the different figures refer to corresponding parts, even if lower-case letters follow them or are omitted.

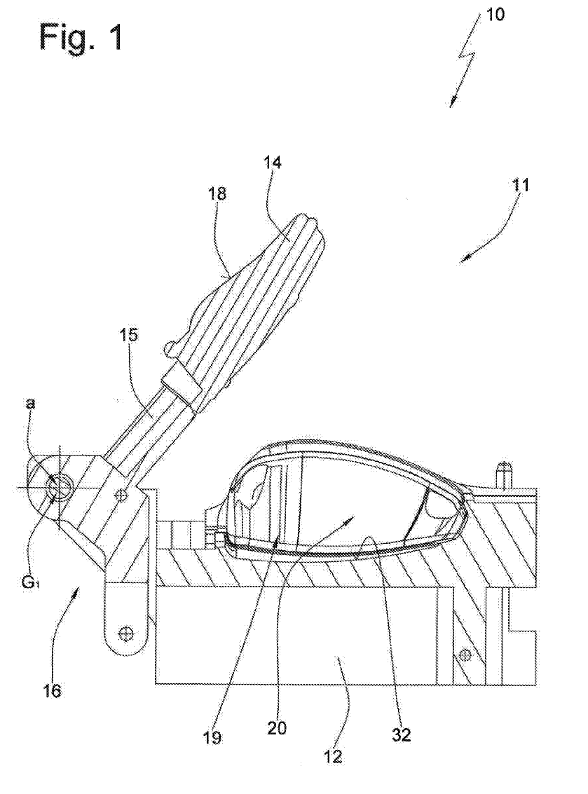

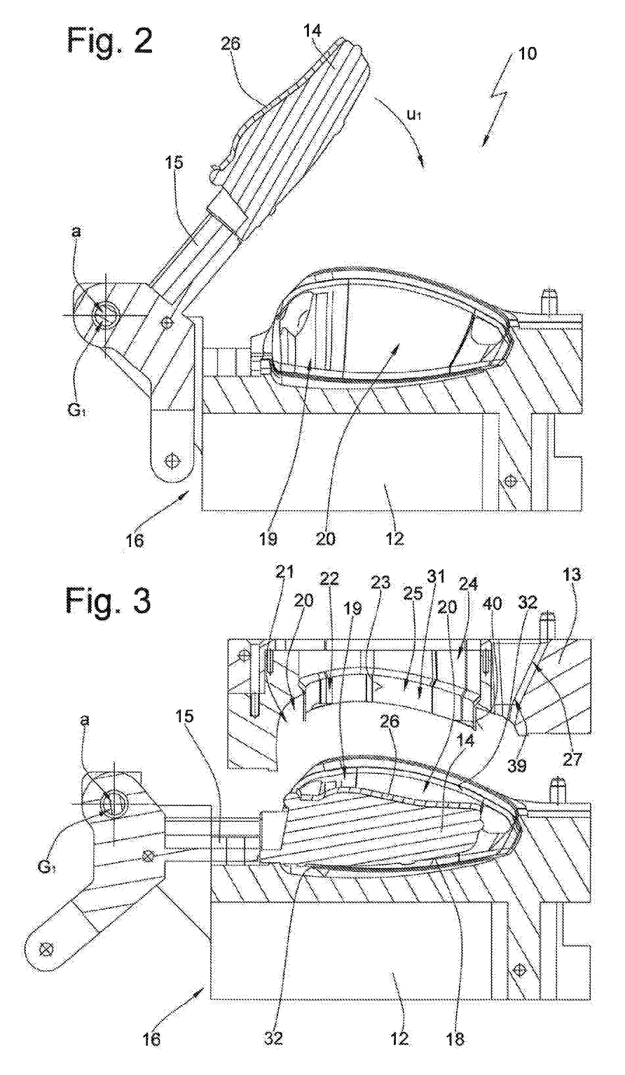

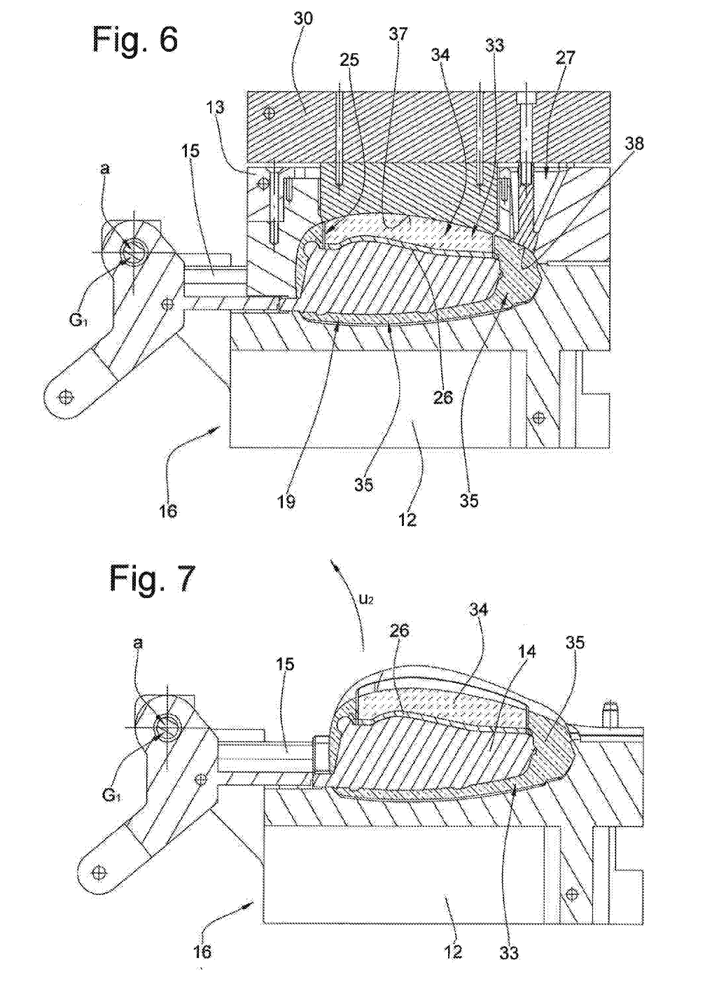

The apparatus 10 comprises a mold 11 shown in FIG. 1 and comprising comprises mold parts 12, 13 (FIGS. 2-5), and 30 (FIG. 6), as well as a mold core 14. The mold core 14 is carried on the mold part 12 by an arm 15 and can pivot about a horizontal pivot axis a. The arm 15 together with an inner end 16 of the mold part 12 forms a pivot joint G1. Thus the mold core 14 can be pivoted between a removal position shown in FIG. 1 and a working position shown for example in FIG. 3.

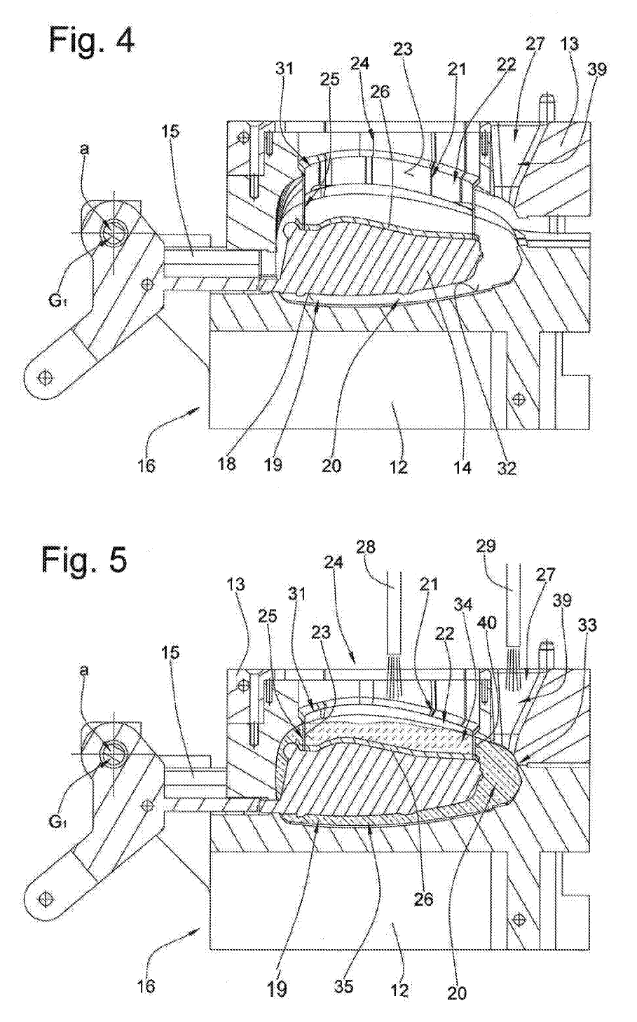

The mold part 13 shown in FIG. 3 can be moved relative to the mold part 12 between an open position (FIG. 1) and a closed position (FIG. 5). In FIG. 1, the mold part 13 is in the open position and the mold core 14 is in the removal position. In FIG. 4, the mold part 13 is shown in a preclosing position. According to FIG. 5, the mold part 13 is shown in the closed position.

The mold part 12 is provided with a recess 19 that forms part of the first mold cavity 20. Another part of the mold cavity 20 is formed by a recess 21 in the other mold part 13. In other words, the recesses 19 and 21 together form the outer envelope of the mold cavity 20. Inner surfaces of the mold parts 12 and 13, together with an outer surface 18 of the mold core 14, delimit the first mold cavity 20.

This first mold cavity 20 is defined by an inner surface 32 of the mold part 12 that borders on the recess 19, by an outer surface 18 of the mold core 14, and by an outer surface 40 of a crosspiece 25. The first mold cavity 20 is provided for forming a back as well as sides of a molded body of a head restraint. The first mold cavity 20 is filled with a foam that forms a relatively hard cushion after it has cured.

A recess 31 in the mold part 13 forms part of the second mold cavity 22. In the closed position of the mold parts 12 and 13, the second mold cavity 22 is delimited by an inner surface 23 of the crosspiece 25, by the outer surface 18 of the mold core 14, and by mold surfaces 37 and 38 of the third mold part 36 (see FIG. 6). The recess 31 is configured as an aperture 24 through the mold part 13, so that the second mold cavity 22 can be filled through the aperture 24 that forms a sprue. The second mold cavity 22 is provided for molding a head contact region of the foam body of a head restraint. For this purpose, it is provided that the second mold cavity is filled with a foam that forms a relatively soft cushion after it cures.

The method of making the foam body is described below. In the position of the apparatus according to FIG. 1, the mold core 14 as well as the mold cavities 20 and 22 are wetted with a parting agent. Subsequently, a connecting mat 26 of polyurethane (PUR) is inserted into the mold 11, for example on the mold core 14, in such a manner (see FIG. 2) that the connecting mat 26 projects into both mold cavities 20 and 22 after the mold core 14 has been moved into the working position. This is the case if the connecting mat 26 is so large that it projects beyond two opposite surfaces 23 and 40 of the crosspiece 25 in the closed state of the mold parts 12 and 13.

In a next method step, the mold core 14 is moved into the working position in the direction u1. In FIG. 3, the mold core 14 is shown in the working position.

When the mold core 14 is in the working position, the second mold part 13 is first pivoted into the preclosing position according to FIG. 4 and subsequently into the closed position according to FIG. 5. Afterward, a first foam is injected into the first mold cavity 20 from a first foam feed line 29 and then through a first sprue 27 (see FIG. 5) formed in the mold part 13, and a second foam is injected into the second mold cavity 22 from a second foam feed line 28 and then through the aperture 24. A passage 39 formed in the mold part 13 extends from the sprue 27 to the second mold cavity 22, so that the second mold cavity 22 can be filled with foam from the sprue 27.

After both mold cavities 20 and 22 have been filled, the mold 11 is closed using a lid-like third mold part 30 (see FIG. 6). The third mold part 30 has the mold surface 37 that delimits the second mold cavity 22 and conforms to regard to the aperture 24. Furthermore, the third mold part 30 has a mold surface 38 that delimits the first mold cavity 20 at the inner end of the sprue 27. The mold 11 remains in this position until the foam in the mold cavities 20 and 22 has cured.

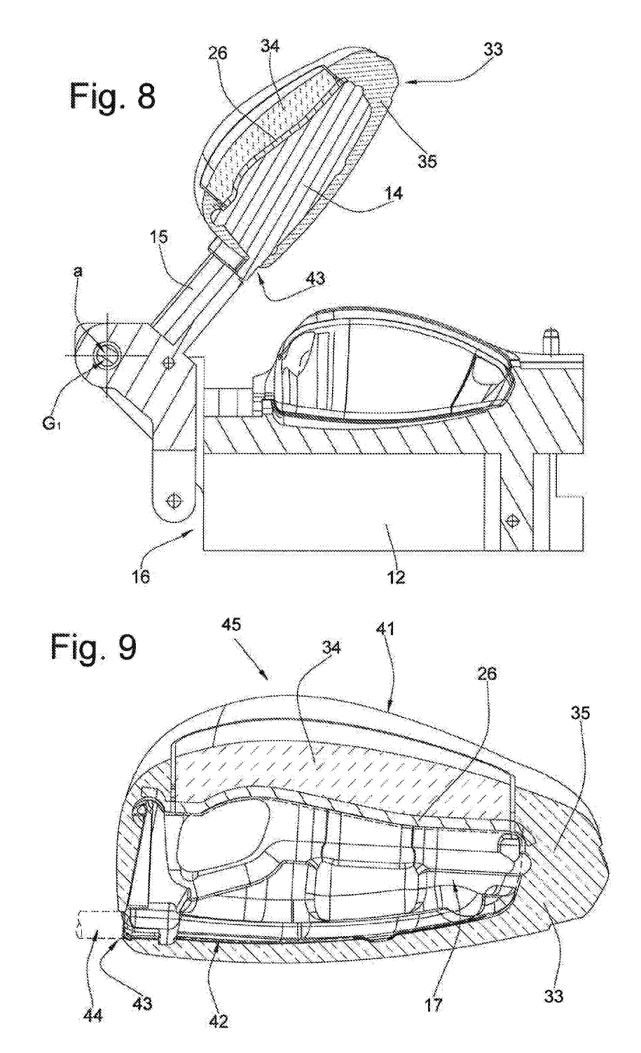

After curing, the mold is moved back into the open position, in that the mold parts 30 and 13 are separated from the mold part 12 (see FIG. 7) and then the mold core 14 is pivoted into the removal position in the direction u2 (see FIG. 8). According to FIG. 8, a finished, cured foam body 33 is on the mold core 14. The foam body 33 can then be removed from the mold core 14. Finally, the mold 11 is cleaned and is then available for another production cycle.

In FIG. 9, a head restraint 45 is shown completely assembled, including the foam body 33. A base part 42 (shown in FIG. 9 by a broken line) of the head restraint 45 is mounted in a cavity 17 of the foam body 33. Support rods 44 that project out of the foam body 33 through an opening 43 in it are also indicated in broken lines. The support rods 44 are attached to the base part 42. The head box 42 can be mounted in the cavity 17 through the opening 43.

The foam body 33 comprises a soft foam part 34 as well as a hard foam part 35. The soft foam part 34 forms at least part of a head contact region 41 of the head restraint 45 after complete installation of the foam body 33 on the base part 42. The hard foam part 35 forms a back, sides, as well as an upper and a lower part of the foam body 33 of the head restraint. The soft foam part 34 is connected with the connecting mat 26 by material fit, and the hard foam part 35 is also connected with the connecting mat 26 with material fit. In other words, the soft foam part 34 and the hard foam part 35 are connected with one another by way of the connecting mat 26.

We claim:

1. An apparatus for making a foam material body has a mold comprising
at least two mold halves fittable together to form separate first and second mold cavities;
a first sprue opening into the first mold cavity; and
a second sprue opening into the second mold cavity.

2. The apparatus defined in claim 1, further comprising:
a mold core engageable in the mold.

3. The apparatus defined in claim 2, wherein the mold core, when in the mold, is between the first and second cavities.

4. The apparatus defined in claim 2, wherein the mold core is movable on the mold between an demolding position outside the mold and a working position inside the mold between the cavities.

5. The apparatus defined in claim 1, further comprising:
a connecting element engageable between the first and second cavities.

6. A method of making a foam material body comprising the steps of:
inserting a connecting element into a mold such that the connecting element projects into a first mold cavity and into a second mold cavity of the mold;
closing the mold;
injecting a first foam into the first mold cavity through a first sprue passage and a second foam into the second mold cavity through a second sprue passage;
curing the foams injected into the first and second cavities;
opening the molded; and
removing a molded part formed by the cured first and second foams from the mold.

7. The method defined in claim 6, further comprising the step of:
fitting a mold core into the mold between the cavities.

8. A foam material body having at least one soft foam part and at least one hard foam part, wherein the soft foam part and the hard foam part are connected, directly or indirectly, with a connecting piece, with material fit and/or shape fit, or with one another.

9. The foam material body defined in claim 8, wherein the connecting piece is a mat, the soft foam part being connected with the mat with material fit and/or shape fit, the hard foam part also being connected with the connecting mat with material fit and/or shape fit.

10. The foam material body defined in claim 8, wherein the foam body forms a cavity in which a head box of a head restraint can be mounted.

11. The foam material body defined in claim 8, wherein at least one of the parts is a polyurethane foam.
